(19) United States
(12) Patent Application Publication
(10) Pub. No.: US 2013/0063369 A1
(43) Pub. Date: Mar. 14, 2013

(54) METHOD AND APPARATUS FOR MEDIA RENDERING SERVICES USING GESTURE AND/OR VOICE CONTROL

(71) Applicants: Abhishek Malhotra, Saharanpur (IN); Balamuralidhar Maddali, Chennai (IN); Anil Kumar Yanamandra, Hyderabad (IN); Chaitanya Kumar Behara, Andhra Pradesh (IN)

(72) Inventors: Abhishek Malhotra, Saharanpur (IN); Balamuralidhar Maddali, Chennai (IN); Anil Kumar Yanamandra, Hyderabad (IN); Chaitanya Kumar Behara, Andhra Pradesh (IN)

(73) Assignee: VERIZON PATENT AND LICENSING INC., Basking Ridge, NJ (US)

(21) Appl. No.: 13/232,429

(22) Filed: Sep. 14, 2011

(51) Int. Cl. G06F 3/041

(52) U.S. Cl. 345/173

(57) ABSTRACT

An approach for providing media rendering services using touch input and voice input. An apparatus invokes a media application and presents media content at the apparatus. The apparatus monitors for touch input and/or voice input to execute a function to apply the media content. The apparatus receives user input as a sequence of user actions, wherein each of the user actions is provided via the touch input or the voice input. The touch input or the voice input is received without presentation of an input prompt that overlays or alters the media content

### BACKGROUND INFORMATION

User devices, such as mobile phones (e.g., smart phones), laptops, netbooks, personal digital assistants (PDAs), etc., provide various forms of media rendering capabilities. Media rendering applications typically operate to allow one or more tasks to be performed to or on the media (e.g., audio, images, video, etc.). These tasks can range from simply presenting the media, to quickly sharing the media with other users around the globe. However, these applications often require navigating multiple on-screen menu steps, along with multiple user actions, to perform the desired task or tasks. Further, traditional on-screen menu actions obscure the media as the user navigates various menu tabs.

Therefore, there is a need to provide media rendering that enhances user convenience without obscuring the rendering process.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a communication system that includes a user device capable of providing media rendering, according to various embodiments;

FIG. 2 is a flowchart of a process for media rendering services, according to an embodiment;

FIG. 3 is a diagram of a media processing platform utilized in the system of FIG. 1, according to an embodiment;

FIGS. 4A and 4B are diagrams of sequences of user actions for invoking a rotation function, according to various embodiments;

FIGS. 5A and 5B are diagrams of sequences of user actions for invoking uploading and downloading functions, according to various embodiments;

FIG. 6 is a diagram of a sequence of user actions for invoking a deletion function, according to an embodiment;

FIG. 7 is a diagram of a sequence of user actions for invoking save function, according to an embodiment;

FIGS. 8A-8C are diagrams of sequences of user actions for invoking a media sharing function, according to various embodiments;

FIG. 9 is a diagram of a sequence of user actions for invoking a cropping function, according to an embodiment;

FIG. 10 is a flowchart of a process for confirming media rendering services, according to an embodiment;

FIG. 11 is a diagram of a mobile device capable of processing user actions, according to various embodiments;

FIG. 12 is a diagram of a computer system that can be used to implement various exemplary embodiments; and

FIG. 13 is a diagram of a chip set that can be used to implement various exemplary embodiments.

### DESCRIPTION OF THE PREFERRED EMBODIMENT

A preferred apparatus, method, and software for media rendering services using gesture and/or voice control are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to mobile devices with built-in media rendering capability, it is contemplated that various exemplary embodiments are also applicable to stationary devices with media rendering capability. In addition, although the following description focuses on the rendering of images, particularly images, various other forms and combinations of media could be implemented (e.g., video, audio, etc.).

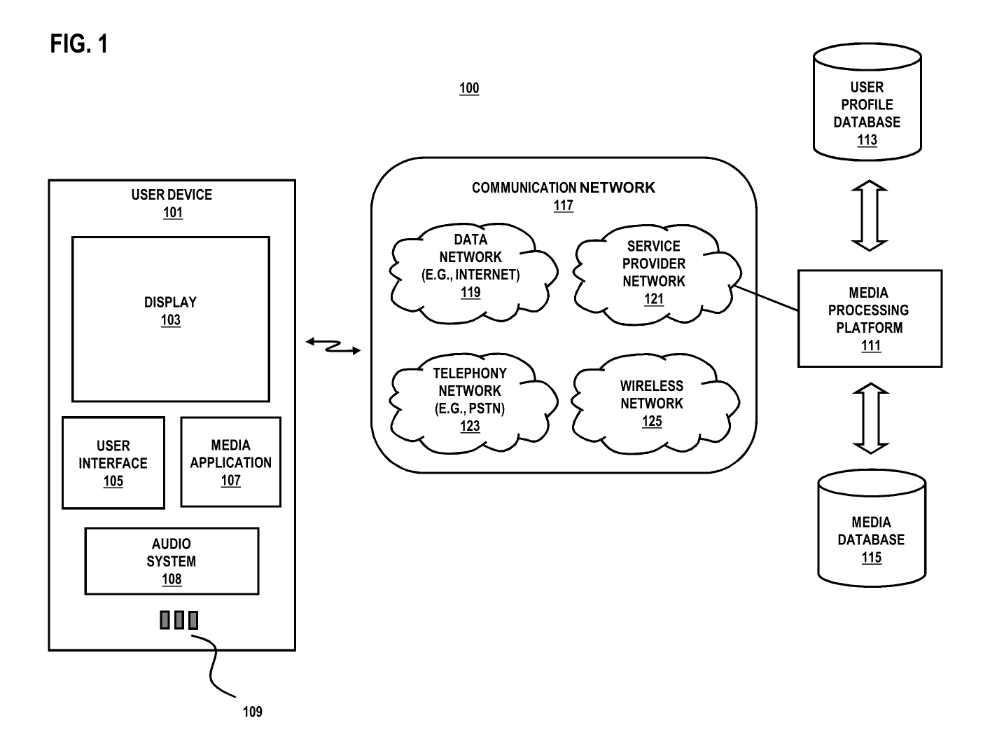

FIG. 1 is a diagram of a system that may include various types of users devices capable of providing media rendering, according to one embodiment. For the purpose of illustration, system 100 employs a user device 101 that includes, for example, a display 103, user interface 105, and a media application 107. The user device 101 is capable of processing user actions to render media content (e.g., images, videos, audio, etc.) by executing one or more functions to apply to or on the media content. For example, the user device 101 may execute a camera or photo application that renders images; thus, such application can benefit from the rendering capability described herein. In addition, the user device 101 may include a user interface 105 for interacting with the user and a media processing platform 111 for executing media application 107. By way of example, media processing platform 111 can be implemented as a managed service. In certain embodiments, the user device 101 can be a mobile device such as cellular phones, BLUETOOTH-enabled devices, WiFi-enable devices, radiophone, satellite phone, smart phone, wireless phone, or any other suitable mobile device, such as a personal digital assistant (PDA), pocket personal computer, tablet, customized hardware, etc., all of which may include a user interface and media application. It is contemplated that the user device 101 may be any number of other processing devices, such as, a laptop, netbook, desktop computer, kiosk, etc.

The display 103 may be configured to provide the user with a visual representation of the media, for example, a display of an image, and monitoring of user actions, via media application 107. The user of user device 101 may invoke the media application 107 to execute rendering functions that are applied to the image. The display 103 is configured to present the image, while user interface 105 enables the user to provide controlling instructions for rendering the image. In certain embodiments, display 103 can be a touch screen display; and the device 101 is capable of monitoring and detecting touch input via the display 103. In certain embodiments, user device 101 includes can include an audio system 108, which among other functions may provide voice recognition capabilities. It is contemplated that any known voice recognition algorithm and/or circuitry may be utilized. As such, the audio system 108 can be configured to monitor and detect voice input, for example, spoken utterances, etc.

The touch input and the voice input can be used separately, or in various combinations, to control any form of rendering function of the image. For example, touch input, voice input, or any combination of touch input and voice input, can be recognized by the user device 101 as controlling measures associated with at least one predetermined rendering function (e.g., saving, deleting, cropping, etc.) that is to be performed on or to the image. In effect, user device 101 can monitor for touch input and voice input as direct inputs from the user in the process of rendering the image. It is contemplated that the rendering process can be performed in a manner that is customized for the particular device, according to one embodiment. In certain embodiments, the image may be stored locally at the user device 101. By way of example, a user device 101 with limited storage capacity may not have the capacity to store images locally, and thus, may retrieve and/or store images to an external database associated with the user device 101. In certain embodiments, the user of user device 101 may access the media processing platform 111 to externally store and retrieve media content (e.g., images). In further embodiments, media processing platform 111 may provide media rendering services, for example, by way of subscription, in which the user subscribes to the services and are then provided with the necessary application(s) to enable the activation of functions to apply to the media content in response to gestures and/or voice commands. In addition, as part of the managed service, users may store media content within the service provider network 121; the repository for the media content may be implemented as a “cloud” service, for example.

According to certain embodiments, the user of the user device 101 may access the features and functionalities of media processing platform 111 over a communication network 117 that can include one or more networks, such as data network 119, service provider network 121, telephony network 123, and/or wireless network 125, in order to access services provided by platform 111. Networks 119-125 may be any suitable wireline and/or wireless network. For example, telephony network 123 may include a circuit-switched network, such as the public switched telephone network (PSTN), an integrated services digital network (ISDN), a private branch exchange (PBX), or other like network.

Wireless network 125 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), long term evolution (LTE), satellite, and the like. Meanwhile, data network 119 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 119-125 may be completely or partially contained within one another, or may embody one or more of the aforementioned infrastructures. For instance, service provider network 121 may embody circuit-switched and/or packet-switched networks that include facilities to provide for transport of circuit-switched and/or packet-based communications. It is further contemplated that networks 119-125 may include components and facilities to provide for signaling and/or bearer communications between the various components or facilities of system 100. In this manner, networks 119-125 may embody or include portions of a signaling system 7 (SS7) network, or other suitable infrastructure to support control and signaling functions.

It is noted that user device 101 may possess computing functionality as to support messaging services (e.g., short messaging service (SMS), enhanced messaging service (EMS), multimedia messaging service (MMS), instant messaging (IM), etc.), and thus, can partake in the services of media processing platform 111—e.g., uploading or downloading of images to platform 111. By way of example, the user device 101 may include one or more processors or circuitry capable of running the media application 107. Moreover, the user device 101 can be configured to operate as a voice over internet protocol (VoIP) phone, skinny client control protocol (SCCP) phone, session initiation protocol (SIP) phone, IP phone, etc.

While specific reference will be made hereto, it is contemplated that system 100 may embody many forms and include multiple and/or alternative components and facilities.

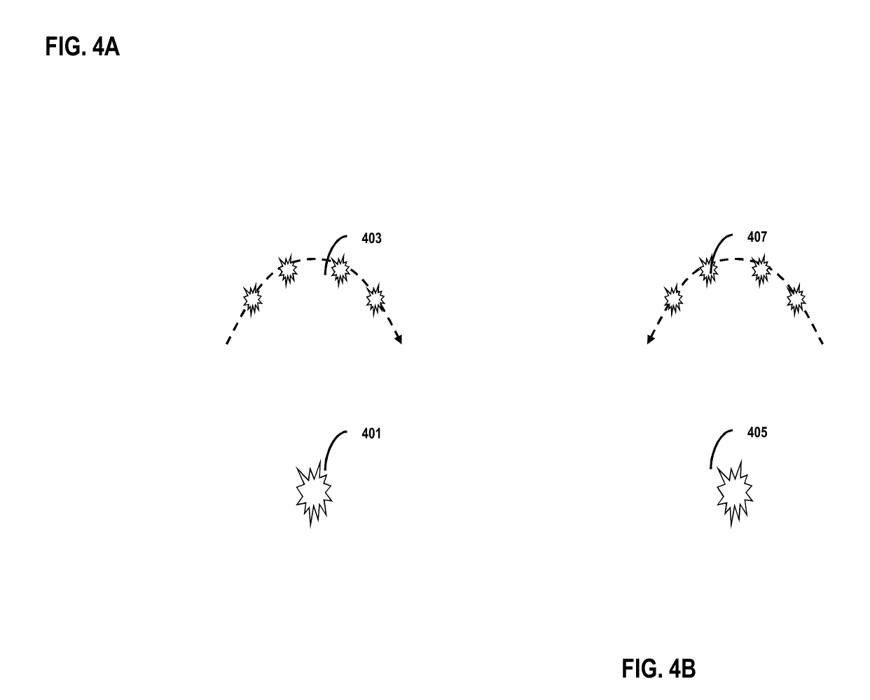

In the example of FIG. 1, user device 101 may be configured to capture images by utilizing an image capture device (e.g., camera) and to store images locally at the device and/or at an external repository (e.g., removable storage device, such as a flash memory, etc.) associated with the device 101. Under this scenario, images can be captured with user device 101, rendered at the user device, and then forwarded over the one or more networks 119-125 via the media application 107. Also, the user device 101 can capture an image, present the image, and based on a user's touch input, voice input, or combination thereof, share the image with another user device (not shown). In other embodiments, the user can control the uploading of the image to the media processing platform 111 by controlling the transfer of the image over one or more networks 119-125 via various messages (e.g., SMS, e-mail, etc.), with a touch input, voice input, or combination thereof. These functions can thus be triggered using a sequence of user actions involving touch input and/or voice input, as explained with respect to FIGS. 4-9.

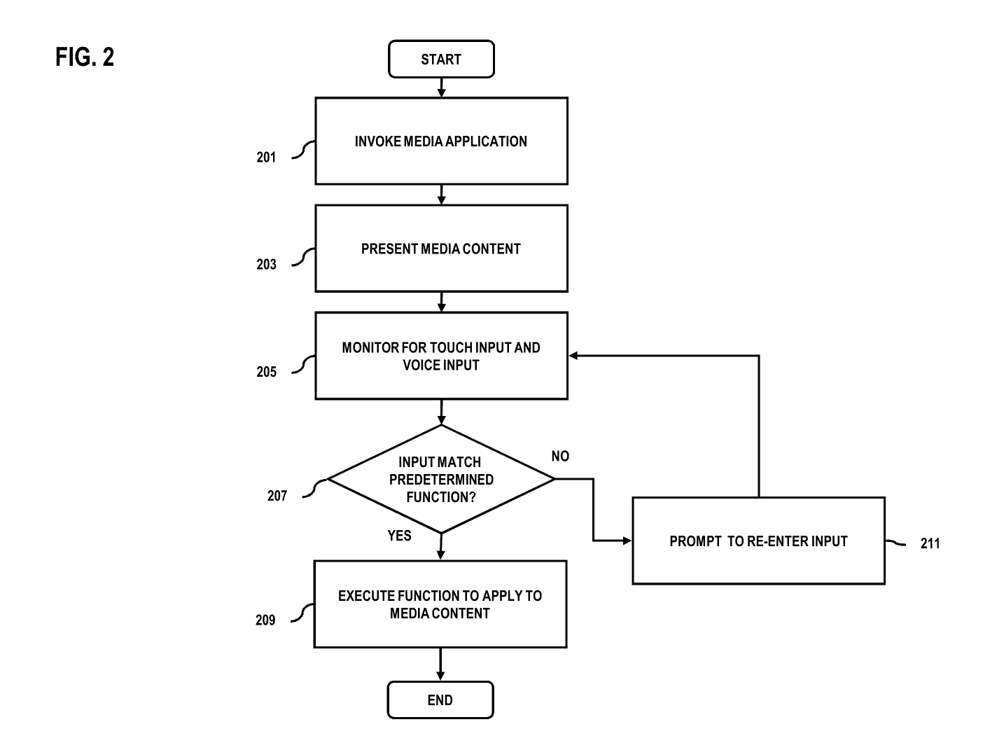

FIG. 2 is a flowchart of a process for media rendering services, according to an embodiment. In step 201, user device 101 invokes media application 107 for providing image rendering services (e.g., execution of a function to apply to the image). In certain embodiments, media application 107 may reside at the user device 101. In other embodiments, media application 107 may reside at the media processing platform 111 in which the user of user device 101 may access the media application 107 via one or more of the networks 117-123. By way of example, the user of user device 101 may desire to render an image on the device 101, and thereby invoke media application 107 via user interface 105 by selecting an icon (not shown) graphically displayed on display 103 and that represents the application 107.

In certain embodiments in which the media application 107 resides at the media processing platform 111, the user can send a request to the media processing platform 111 to indicate a desire to render an image via the media application 107. The platform 111 may receive the request via a message, e.g., text message, email, etc. Upon receiving the request, the platform 111 may verify the identity of the user by accessing a user profile database 113. If the user is a subscriber, platform 111 can proceed to process the request for manipulating the image (e.g., activate the application). If the user is not a subscriber, platform 111 may deny the user access to the service, or may prompt the user to become a subscriber before proceeding to process the request. In processing the request, platform 111 may then provide user device 101 access to the media application 107.

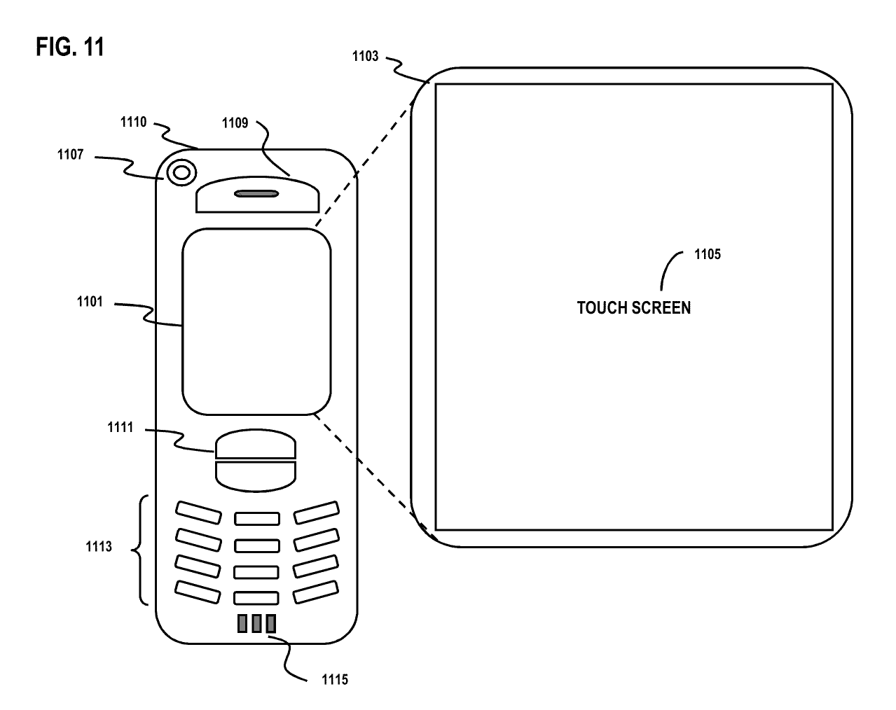

In step 203, the user device 101 presents an image on display 103 of the device 101. Alternatively, the display 103 may be an external device (not shown) associated and in communication with device 101. In addition, the display 103 may be a touch screen display that can be used to monitor and detect the presence and location of a touch input within the display area (as shown in FIG. 11). The touch screen display enables the user to interact directly with the media application 107 via the user interface 105. In addition, the user device 101 can allow the user interact with the media application 107 by voice inputs. The touch input can be in the form of user actions, such as a gesture including one or more touch points and patterns of subsequent touch points (e.g., arches, radial columns, crosses, etc.).

In certain embodiments, media processing platform 111 may store received images in an media database 115, for example, prior to invoking the media application the user has uploaded the images to the media processing platform 111 for storage in an media database 115 associated with the platform 111. The stored image can be retrieved and transmitted via one or more of the networks 119-125 to the user device 101 for rendering when the media application 107 is invoked. In certain embodiments, the user device 101 may transmit the image to the platform 111, post rendering, for storage in the media database 115.

In step 205, the user device 101 monitors for touch input and/or voice input provided by the user. The display 103 can monitor for touch input that may be entered by the user touching the display 103. In certain embodiments, the touch input may be provided by the user via an input device (not shown), such as any passive object (e.g., stylus, etc.). For example, the user can touch the touch display 103 with a finger, or with a stylus, to provide a touch input. In certain embodiments, the touch input and/or voice input can be received as a sequence of user actions provided via the touch input and/or voice input. The sequence of user actions can include, for example, a touch point and multiple touch points and/or subsequent multiple touch points that form one or more patterns (e.g., column, arch, check, swipe, cross, etc.).

Unlike the traditional approach, in some embodiments, the user input (e.g., touch input, the voice input, or combination thereof) is proactively provided by the user without presentation of an input prompt (within the display 103) that overlays or alters the media content. By way of example, input prompt, as used herein, can be an image (e.g., icon), a series of images, or a menu representing control functions to apply to the media content. These control functions can correspond to the functions described with respect to FIGS. 4-9. In this manner, the rendered media content is in no way obscured or otherwise altered (e.g., media content is resized to fit a menu). That is, the display 103 will not have a menu or images displayed for the purposes of manipulating the media contented. As indicated, traditionally, a menu or control icons may appear on top of the images or would alter the images to present such a menu or control icons.

In certain embodiments, the voice input can be in any form, including, for example, a spoken utterance by the user. In certain embodiments, user device may include a microphone 109 that can be utilized to monitor and detect the voice input. For example, the microphone 109 can be a built-in microphone of the user device 101 or may be an external microphone associated with and in communication with the device 101.

In step 207, the user device 101 via media application 107 determines whether an received input corresponds to a predetermined function. By way of example, the user device 101 determines whether a received touch input and/or voice input matches a predetermined function of a plurality of predetermined functions that can be applied to media content. The predetermined functions can correspond to a touch input, a voice input, or any combination thereof. The predetermined functions, and how they correlate to user input, can be customized by the user of user device 101, and/or by a service provider of media application 107, via media application 107.

If the input that the user provides is determined to match a predetermined function, the application 107 determines that the user desires to execute the predetermined function to apply to the media content. For example, if user input is determined to match at least one predetermined function, the user device 101, via application 107, can execute a rendering function to be applied to the image, in step 209. The user device 101 may declare that the predetermined function has been applied to the image. If the user input does not match a predetermined function, the user device may prompt the user to re-enter the input, in step 211.

Advantageously, the user has the direct ability to conveniently control execution of a media content rendering function without obscuring the rendering process.

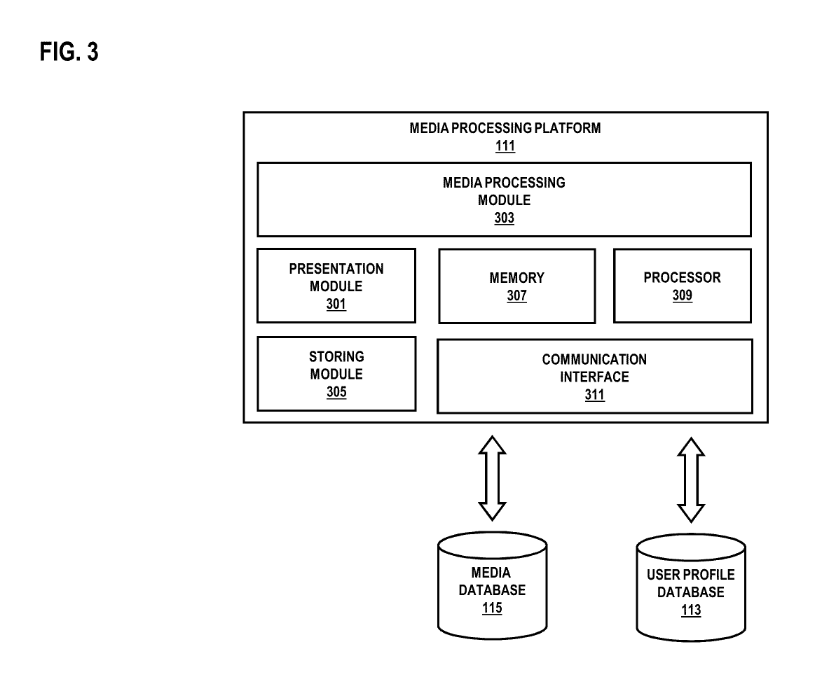

FIG. 3 is a diagram of a media processing platform utilized in the system of FIG. 1, according to an embodiment. By way of example, the media processing platform 111 may include a presentation module 301, media processing module 303, storing module 305, memory 307, processor 309, and communication interface 311, to provide media processing services. It is noted that the modules 301-311 encompassing of the media processing platform 111 can be implemented in hardware, firmware, software, or a combination thereof. In addition, the media processing platform 111 maintains one or more repositories or databases: user profile database 113, and media database 115.

By way of example, user profile database 113 is a repository that can be maintained for housing data corresponding to user profiles (e.g., users of devices 101) of subscribers. Also, as shown, a media database 115 is maintained by media processing platform 111 for expressly storing images forwarded from user devices (e.g., device 101). In certain embodiments, the media processing platform 111 may maintain registration data stored within user profile database 113 for indicating which users and devices are subscribed to participate in the services of media processing platform 111. By way of example, the registration data may indicate profile information regarding the subscribing users and their registered user device(s) 101, profile information regarding affiliated users and user devices 101, details regarding preferred subscribers and subscriber services, etc., including names, user and device identifiers, account numbers, predetermined inputs, service classifications, addresses, contact numbers, network preferences and other like information. Registration data may be established at a time of initial registration with the media processing platform 111.

In some embodiments, the user of user device 101 can communicate with the media processing platform 111 via user interface 105. For example, one or more user devices 101 can interface with the platform 111 and provide and retrieve images from platform 111. A user can speak a voice utterance as a control mechanism to direct a rendering of an image, in much the same fashion as that of the touch input control. In certain embodiments, both touch input and voice input correspond to one or more predetermined functions that can be performed on or to an image. According to certain embodiments, the devices 101 of FIG. 1 may monitor for both touch input and voice input, and likewise, may detect both touch input and voice input. User voice inputs can be configured to correspond to predetermined functions to be performed on an image or images. The voice inputs can be defined by the detected spoken utterance, and the timing between spoken utterances, by the audio system 108 of the device 101; alternatively, the voice recognition capability may be implemented by platform 111.

The presentation module 301 is configured for presenting images to the user device 101. The presentation module 301 may also interact with processor 309 for configuring or modifying user profiles, as well as determining particular customizable services that a user desires to experience.

In one embodiment, media processing module 303 processes one or more images and associated requests received from a user device 101. The media processing module 303 can verify that the quality of the one or more received images is sufficient for use by the media processing platform 111, as to permit processing. If the media processing platform 111 detects that the images are not of sufficient quality, the platform 111, as noted, may take measures to obtain sufficient quality images. For example, the platform 111 may request that additional images are provided. In other embodiments, the media processing module 303 may alter or enhance the received images to satisfy quality requirements of the media processing platform 111.

In one embodiment, one or more processors (or controllers) 309 for effectuating the described features and functionalities of the media processing platform 111, as well as one or more memories 307 for permanent and/or temporary storage of the associated variables, parameters, information, signals, etc., are utilized. In this manner, the features and functionalities of subscriber management may be executed by processor 309 and/or memories 307, such as in conjunction with one or more of the various components of media processing platform 111.

In one embodiment, the various protocols, data sharing techniques and the like required for enabling collaboration over the network between user device 101 and the media processing platform 111 is provided by the communication interface 311. As the various devices may feature different communication means, the communication interface 311 allows the media processing platform 111 to adapt to these needs respective to the required protocols of the service provider network 119. In addition, the communication interface 311 may appropriately package data for effective receipt by a respective user device, such as a mobile phone. By way of example, the communication interface 311 may package the various data maintained in the user profile database 113 and media database 115 for enabling shared communication and compatibility between different types of devices.

In certain embodiments, the user interface 105 can include a graphical user interface (GUI) that can be presented via the user device 101 described with respect to the system 100 of FIG. 1. For example, the GUI is presented via display 103, which as noted may be a touch screen display. The user device 101, via the media application 107 and GUI can monitor for a touch input and/or a voice input as an action, or a sequence of user actions. The touch screen display is configured to monitor and receive user input as one or more touch inputs. User touch inputs can be configured to correspond to predetermined functions to be applied on an image or images. The touch inputs can be defined by the number of touch points—e.g., a series of single touches for a predetermined time period and/or predetermined area size. The area size permits the device 101 to determine whether the input is a touch, as a touch area that exceeds the predetermined area size may register as an accidental input or may register as a different operation. The time period and area size can be configured according to user preference and/or application requirements. The touch inputs can be further defined by the one or more touch points and/or subsequent touch points and the patterns (e.g., the degree of angle between touch points, length of patterns, timing between touch points, etc.) on the touch screen that are formed by the touch points. In certain embodiments, the definition of touch inputs and the rendering functions that they correspond to can be customized by the user of user device 101, and/or by a provider of media processing platform 111. For example, to execute a desired function to be applied to an image, the touch input required by the user could include two parallel swipes of multiple touch points that are inputted within, e.g., 3 seconds of each other. In certain embodiments, to the desired function can be executed by the required touch input and/or a required voice input. For example, to execute the desired function to be applied to an image, the voice input required by the user could include a spoken utterance that matches a predetermined word or phrase. Advantageously, a user is able to directly provide controlling inputs that result in an immediate action performed on an image without requiring multiple menu steps and without obscuring the subject image.

FIGS. 4A and 4B are diagrams of sequences of user actions for invoking a rotation function, according to various embodiments. FIG. 4A depicts a single touch point 401 and an arch pattern of subsequent touch points 403 perform on a touch screen of a display. The single touch point 401 can be the initial user action, and the arch pattern of subsequent touch points 403 can be the second user action that is performed about the pivot of single touch point 401 in a clockwise direction. For example, the combination of the touch point 401 and the angular swiping action 403 can be configured to result in an execution of a clockwise rotation of an image presented on the touch screen display. FIG. 4B depicts two user actions, a single touch point 405 and an arch pattern of subsequent touch points 407, which when combined, can be configured to result in, for example, an execution of a counter-clockwise rotation of an image, in similar fashion as the clockwise rotation of the image depicted in FIG. 4A. It is contemplated that the described user actions may be utilized for any other function pertaining to the rendered media content.

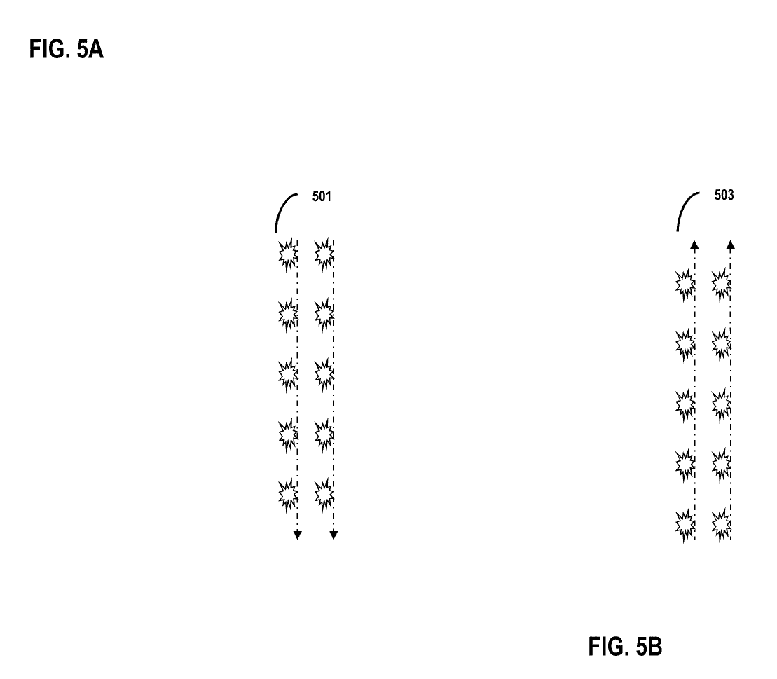

FIGS. 5A and 5B are diagrams of sequences of user actions for invoking uploading and downloading functions, according to various embodiments. FIG. 5A depicts a downward double column of touch points 501 performed in a downward direction on a touch screen. The downward double column of touch points 501 may be configured to correspond to an execution of a download of image content graphically depicted on the touch screen. For example, the media content could be downloaded to the user device 101. FIG. 5B depicts an upward double column of touch points 503 performed in an upward direction on a touch screen. The upward double column of touch points 503 may be configured to correspond to an execution of an upload of media content displayed on the touch screen. For example, an image could be uploaded to the user device 101, or to any other device capable of performing such an upload.

In certain embodiments, single columns of touch points in downward, upward, or lateral directions, could be configured to correspond to a function to apply, for example, scrolling or searching functions to be applied to media.

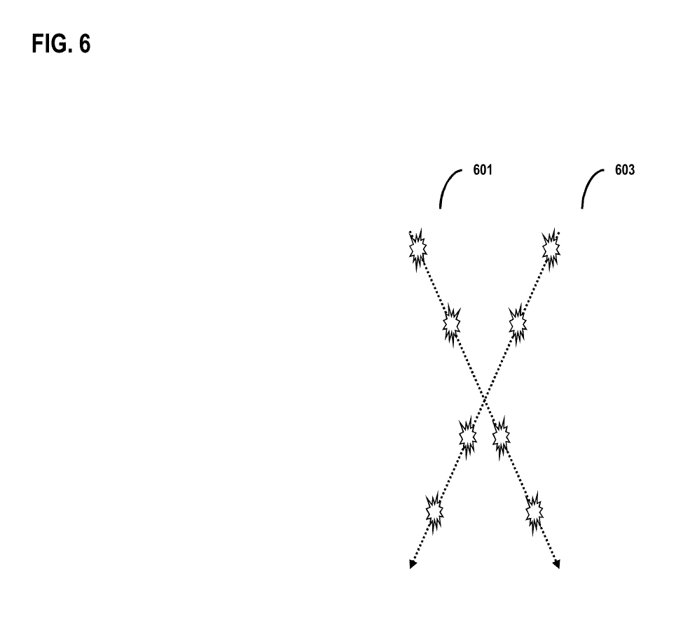

FIG. 6 is a diagram of a sequence of user actions for invoking a deletion function, according to an embodiment. Specifically, FIG. 6 depicts a first diagonal pattern of touch points 601 and a second diagonal pattern of touch points 603 performed on a touch screen. In some embodiments, the first diagonal pattern of touch points 601 and the second diagonal pattern of touch points 603 crisscross. The combination of the first diagonal pattern of touch points 601 and the second diagonal pattern of touch points 603 may be configured to correspond to an execution of a deletion of media content. In certain embodiments, the second diagonal pattern of touch points 603 can be inputted before the first diagonal pattern of touch points 601.

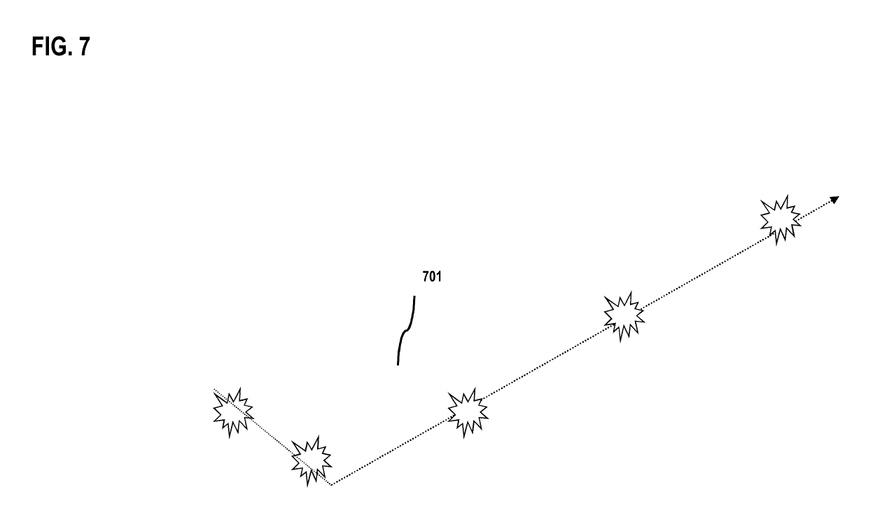

FIG. 7 is a diagram of a sequence of user actions for invoking save function, according to an embodiment. FIG. 7 depicts a check pattern 701. The check pattern 701 may be configured to correspond to an execution of saving of media content. In certain embodiments, the check pattern 701 can be defined as a pattern having with a wide or narrow range of acceptable angles between a first leg and a second leg of the check pattern 701.

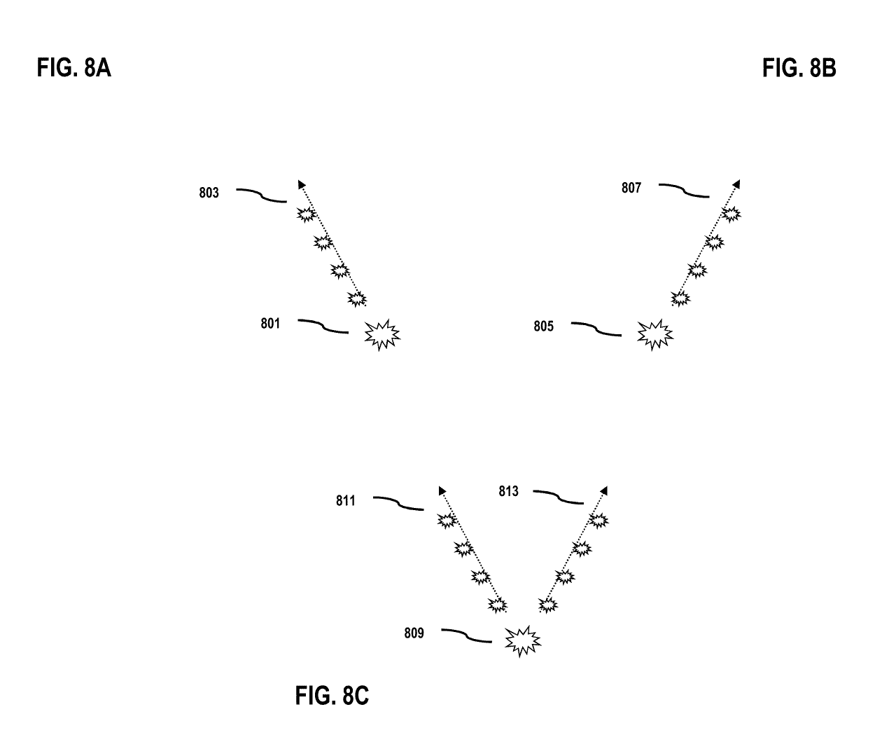

FIGS. 8A-8C are diagrams of sequences of user actions for invoking a media sharing function, according to various embodiments. FIG. 8A depicts an initial touch point 801 and an upward diagonal patter of subsequent touch points 803 extending away from the initial touch point 801. The combination of the initial touch point 801 and the upward diagonal patter of subsequent touch points 803 may be configured to correspond to an execution of sharing media content. FIG. 8B depicts another embodiment of a similar combination comprising an initial touch point 805 and an upward diagonal patter of subsequent touch points 807 that is inputted in a different direction. FIG. 8C depicts another embodiment that combines users action inputs depicted in FIGS. 8A and 8B. FIG. 8C depicts an initial touch point 809, a first upward diagonal patter of subsequent touch points 811, and second upward diagonal patter of subsequent touch points 813. The combination of the initial touch point 809, first upward diagonal patter of subsequent touch points 811, and second upward diagonal patter of subsequent touch points 813 can also be configured to correspond to an execution of sharing media content.

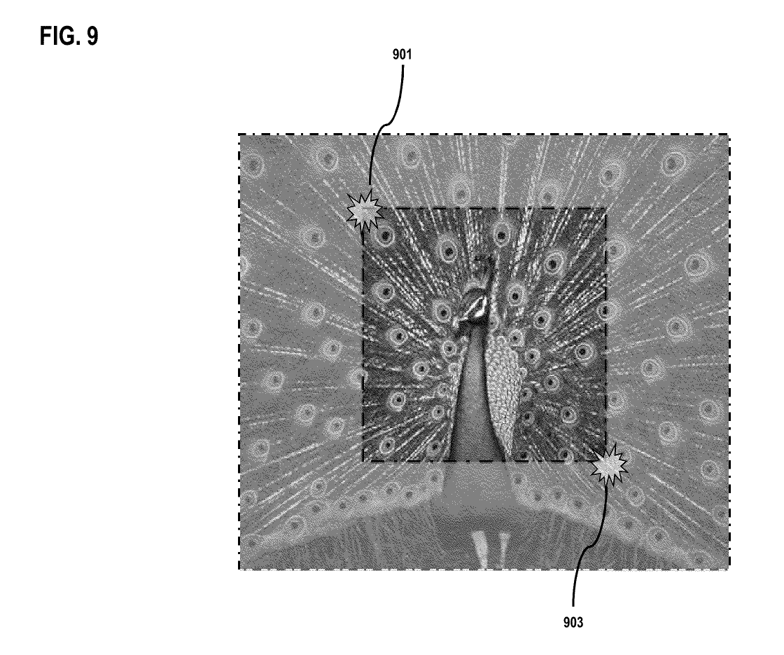

FIG. 9 is a diagram of a sequence of user actions for invoking a cropping function, according to an embodiment. In particular, FIG. 9 depicts a first long touch point 901 and a second long touch point 903 that form a virtual window on the display. In certain embodiments, the multiple touch points 901 and 903 can be dragged diagonally, in either direction, to increase or decrease the size of the window. The combination of the first long touch point 901 and the second long touch point 903 can be configured to correspond an execution of cropping of the media content, in which the virtual window determines the amount of the image to be cropped.

As seen, the user can manipulate the image without invoking a menu of icons that may obscure the image—e.g., no control icons are presented to the user to resize the window. The user simply can perform the function without the need for a prompt to be shown.

Although the user actions depicted in FIGS. 4-9 are explained with respect to particular functions, it is contemplated that such actions can be correlated to any other one of the particular functions as well as to other functions not described in these use cases.

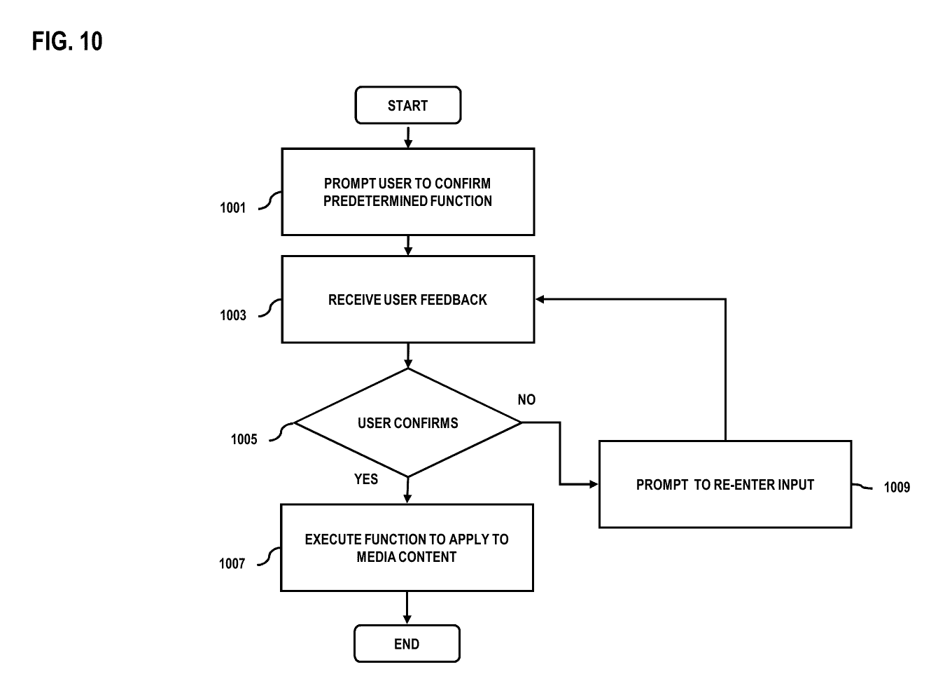

FIG. 10 is a flowchart of a process for confirming media rendering services, according to an embodiment. In step 1001, user device 101 via media application 107 prompts a user via user device 101 to confirm that a predetermined function determined to correspond to a received input in step 207 is the predetermined function desired by the user. By way of example, the user may provide a voice input as a spoken utterance, which is determined to correspond to predetermined function (e.g., uploading of the image). The user device 101, in step 1001, prompts the user to confirm the determined predetermined function, by presenting the determined predetermined function graphically on the display 103 or by audio via a speaker (not shown).

In step 1003, the user device 101 receives the user's feedback regarding the confirmation of the determined predetermined function. In certain embodiments, the user may provide feedback via voice input or touch input. For example, the user may repeat the original voice input to confirm the desired predetermined function. In other examples, user may also provide affirmative feedback to the confirmation request by saying “YES” or “CONFIRMED,” and similarly, may provide negative feedback to the conformation request by saying “NO” “INCORRECT.” In further embodiments, the user may provide a touch input via the touch screen to confirm or deny confirmation. For example, the user may select provide a check pattern of touch points to indicate an affirmative answer, and similarly, may provide a first diagonal pattern of touch points and second pattern of touch points to indicate a negative answer.

The user device 101 determines whether the user confirms the determined predetermined function to be applied to media content, in step 1005. If the user device 101 determines that the user has confirmed the predetermined function, the user device executes the predetermined function to apply to the media content, in step 1007. If the user device 101 determines that the user has not confirmed the predetermined function, the user device 101 prompts the user to re-enter input in step 1009.

FIG. 11 is a diagram of a mobile device capable of processing user actions, according to various embodiments. In this example, screen 1101 includes graphic window 1103 that provides a touch screen 1105. The screen 1101 is configured to present an image or multiple images. The touch screen 1105 is receptive of touch input provided by a user. Using the described processes, media content (e.g., images) can be rendered and presented on the touch screen 1105, and user input (e.g., touch input, the voice input, or combination thereof) is received without any prompts (by way of menus or icons representing media controls (e.g., rotate, resize, play, pause, fast forward, review, etc.). Because no prompts are needed, the media content (e.g., photo) is not altered by any extraneous image, thereby providing a clean photo. Accordingly, the user experience is greatly enhanced.

As shown, the mobile device 1100 (e.g., smart phone) may also comprise a camera 1107, speaker 1109, buttons 1111, and keypad 1113, and microphone 1115. The microphone 1115 can be configured to monitor and detect voice input.

The processes described herein for providing media rendering services using gesture and/or voice control may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

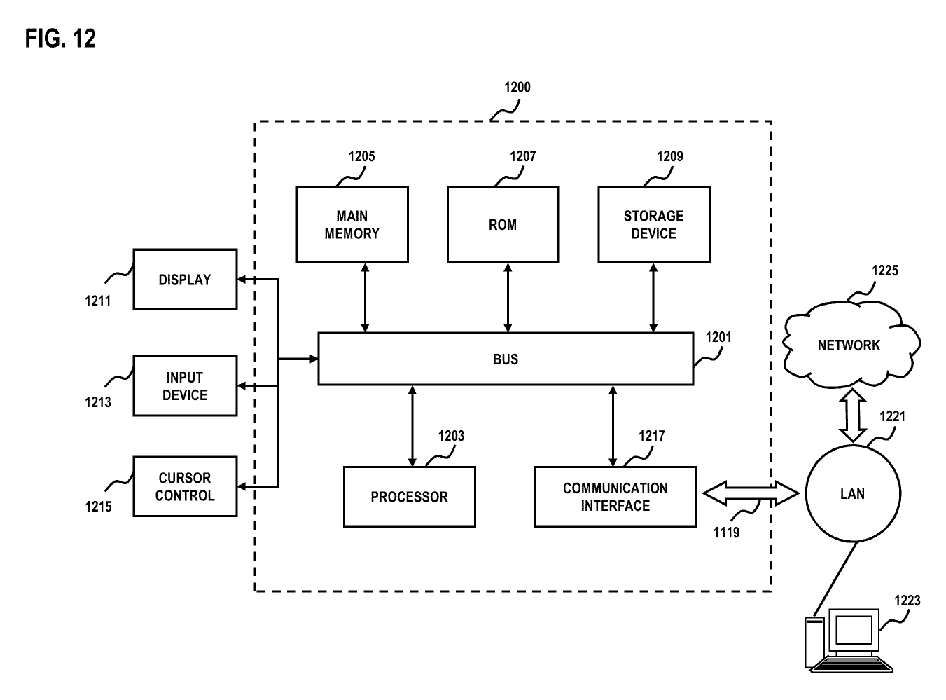

FIG. 12 is a diagram of a computer system that can be used to implement various exemplary embodiments. The computer system 1200 includes a bus 1201 or other communication mechanism for communicating information and one or more processors (of which one is shown) 1203 coupled to the bus 1201 for processing information. The computer system 1200 also includes main memory 1205, such as a random access memory (RAM) or other dynamic storage device, coupled to the bus 1201 for storing information and instructions to be executed by the processor 1203. Main memory 1205 can also be used for storing temporary variables or other intermediate information during execution of instructions by the processor 1203. The computer system 1200 may further include a read only memory (ROM) 1207 or other static storage device coupled to the bus 1201 for storing static information and instructions for the processor 1203. A storage device 1209, such as a magnetic disk or optical disk, is coupled to the bus 1201 for persistently storing information and instructions.

The computer system 1200 may be coupled via the bus 1201 to a display 1211, such as a cathode ray tube (CRT), liquid crystal display, active matrix display, or plasma display, for displaying information to a computer user. An input device 1213, such as a keyboard including alphanumeric and other keys, is coupled to the bus 1201 for communicating information and command selections to the processor 1203. Another type of user input device is a cursor control 1215, such as a mouse, a trackball, or cursor direction keys, for communicating direction information and command selections to the processor 1203 and for adjusting cursor movement on the display 1211.

According to an embodiment of the invention, the processes described herein are performed by the computer system 1200, in response to the processor 1203 executing an arrangement of instructions contained in main memory 1205. Such instructions can be read into main memory 1205 from another computer-readable medium, such as the storage device 1209. Execution of the arrangement of instructions contained in main memory 1205 causes the processor 1203 to perform the process steps described herein. One or more processors in a multiprocessing arrangement may also be employed to execute the instructions contained in main memory 1205. In alternative embodiments, hard-wired circuitry may be used in place of or in combination with software instructions to implement the embodiment of the invention. Thus, embodiments of the invention are not limited to any specific combination of hardware circuitry and software.

The computer system 1200 also includes a communication interface 1217 coupled to bus 1201. The communication interface 1217 provides a two-way data communication coupling to a network link 1219 connected to a local network 1221. For example, the communication interface 1217 may be a digital subscriber line (DSL) card or modem, an integrated services digital network (ISDN) card, a cable modem, a telephone modem, or any other communication interface to provide a data communication connection to a corresponding type of communication line. As another example, communication interface 1217 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1217 sends and receives electrical, electromagnetic, or optical signals that carry digital data streams representing various types of information. Further, the communication interface 1217 can include peripheral interface devices, such as a Universal Serial Bus (USB) interface, a PCMCIA (Personal Computer Memory Card International Association) interface, etc. Although a single communication interface 1217 is depicted in FIG. 12, multiple communication interfaces can also be employed.

The network link 1219 typically provides data communication through one or more networks to other data devices. For example, the network link 1219 may provide a connection through local network 1221 to a host computer 1223, which has connectivity to a network 1225 (e.g. a wide area network (WAN) or the global packet data communication network now commonly referred to as the “Internet”) or to data equipment operated by a service provider. The local network 1221 and the network 1225 both use electrical, electromagnetic, or optical signals to convey information and instructions. The signals through the various networks and the signals on the network link 1219 and through the communication interface 1217, which communicate digital data with the computer system 1200, are exemplary forms of carrier waves bearing the information and instructions.

The computer system 1200 can send messages and receive data, including program code, through the network(s), the network link 1219, and the communication interface 1217. In the Internet example, a server (not shown) might transmit requested code belonging to an application program for implementing an embodiment of the invention through the network 1225, the local network 1221 and the communication interface 1217. The processor 1203 may execute the transmitted code while being received and/or store the code in the storage device 1209, or other non-volatile storage for later execution. In this manner, the computer system 1200 may obtain application code in the form of a carrier wave.

The term “computer-readable medium” as used herein refers to any medium that participates in providing instructions to the processor 1203 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 1209. Volatile media include dynamic memory, such as main memory 1205. Transmission media include coaxial cables, copper wire and fiber optics, including the wires that comprise the bus 1201. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

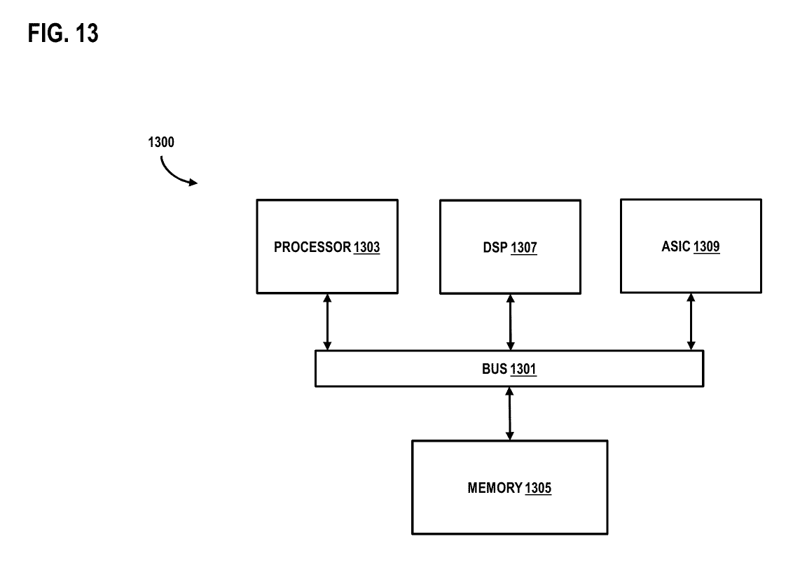

FIG. 13 illustrates a chip set or chip 1300 upon which an embodiment of the invention may be implemented. Chip set 1300 is programmed to configure a mobile device to enable processing of images as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1300 can be implemented in a single chip. It is further contemplated that in certain embodiments the chip set or chip 1300 can be implemented as a single “system on a chip.” It is further contemplated that in certain embodiments a separate ASIC would not be used, for example, and that all relevant functions as disclosed herein would be performed by a processor or processors. Chip set or chip 1300, or a portion thereof, constitutes a means for performing one or more steps of providing user interface navigation information associated with the availability of functions. Chip set or chip 1300, or a portion thereof, constitutes a means for performing one or more steps of configuring a mobile device to enable accident detection and notification functionality for use within a vehicle.

In one embodiment, the chip set or chip 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1300 includes merely one or more processors and some software and/or firmware supporting and/or relating to and/or for the one or more processors.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to configure a mobile device to enable accident detection and notification functionality for use within a vehicle. The memory 1305 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
invoking a media application on a user device;
presenting media content on a display of the user device;
monitoring for a touch input or a voice input to execute a function to apply to the media content; and
receiving the touch input or the voice input without presentation of an input prompt that overlays or alters the media content.

2. A method according to claim 1, further comprising:
receiving user input as a sequence of user actions, wherein each of the user actions is provided via the touch input or the voice input.

3. A method according to claim 1, further comprising:
detecting the sequence of user actions to include,
a touch point, and
an arch pattern of subsequent touch points.

4. A method according to claim 1, further comprising:
detecting the sequence of user actions to include,
an upward double column of touch points, or
a downward double column of touch points.

5. A method according to claim 1, further comprising:
detecting the sequence of user actions to include,
a first diagonal pattern of touch points, and
a second diagonal pattern of touch points, the second diagonal pattern intersecting the first diagonal pattern.

6. A method according to claim 1, further comprising:
detecting the sequence of user actions to include,
a check pattern of touch points.

7. A method according to claim 1, further comprising:
detecting the sequence of user actions to include,
an initial touch point,
an upward diagonal pattern of subsequent touch points extending away from the initial touch point.

8. A method according to claim 1, further comprising:
detecting the sequence of user actions to include,
an initial touch point,
a first upward diagonal pattern of subsequent touch points away from the initial touch point, and
a second upward diagonal pattern of subsequent touch points away from the initial touch point.

9. An apparatus comprising:
a processor; and
at least one memory including computer program instructions,
the at least one memory and the computer program instructions configured to, with the processor, cause the apparatus to perform at least the following:
invoke a media application on the apparatus;
present media content on a display of the apparatus;
monitor for a touch input or a voice input to execute a function to apply to the media content; and
receive the touch input or the voice input without presentation of an input prompt that overlays or alters the media content.

10. The apparatus according to claim 9, wherein the apparatus is further caused to receive user input as a sequence of user actions, wherein each of the user actions is provided via the touch input or the voice input.

11. The apparatus according to claim 9, wherein the apparatus is further caused to detect the sequence of user actions to include,
a touch point, and
an arch pattern of subsequent touch points.

12. The apparatus according to claim 9, wherein the apparatus is further caused to detect the sequence of user actions to include,
an upward double column of touch points, or
a downward double column of touch points.

13. The apparatus according to claim 9, wherein the apparatus is further caused to detect the sequence of user actions to include,
a first diagonal pattern of touch points, and
a second diagonal pattern of touch points, the second diagonal pattern intersecting the first diagonal pattern.

14. The apparatus according to claim 9, wherein the apparatus is further caused to detect the sequence of user actions to include,
a check pattern of touch points.

15. The apparatus according to claim 9, wherein the apparatus is further caused to detect the sequence of user actions to include,
an initial touch point,
an upward diagonal pattern of subsequent touch points extending away from the initial touch point.

16. The apparatus according to claim 9, wherein the apparatus is further caused to detect the sequence of user actions to include,
an initial touch point,
a first upward diagonal pattern of subsequent touch points away from the initial touch point, and
a second upward diagonal pattern of subsequent touch points away from the initial touch point.

17. An apparatus comprising:
a display;
at least one processor configured to invoke a media application on the apparatus and present media content on the display; and
at least one memory,
wherein the at least one processor is further configured to monitor for touch input or voice input to execute a function to apply to the media content, and to receive the touch input or the voice input without presentation of an input prompt that overlays or alters the media content.

18. The apparatus according to claim 17, wherein the at least one processor is further configured to receive user input as a sequence of user actions, wherein each of the user actions is provided via the touch input or the voice input.

19. The apparatus according to claim 17, wherein the at least one processor is further configured to detect the sequence of user actions to include,
a touch point, and
an arch pattern of subsequent touch points.

20. The apparatus according to claim 17, wherein the at least one processor is further configured to detect the sequence of user actions to include,
a first diagonal pattern of touch points, and
a second diagonal pattern of touch points, the second diagonal pattern intersecting the first diagonal pattern.
